(19) United States
(12) Patent Application Publication
(10) Pub. No.: US 2011/0039157 A1
(43) Pub. Date: Feb. 17, 2011

(54) ANODIC CARBON MATERIAL FOR LITHIUM SECONDARY BATTERY, METHOD FOR MANUFACTURING THE SAME, LITHIUM SECONDARY BATTERY ANODE, AND LITHIUM SECONDARY BATTERY

(75) Inventors: Tatsuro Sasaki, Tokyo (JP); Tetsushi Ono, Tokyo (JP); Tsuyoshi Watanabe, Tokyo (JP)

Correspondence Address: Ditthavong Mori & Steiner, P.C., 918 Prince Street, Alexandria, VA, 22314, US

(73) Assignee: Sumitomo Bakelite Co., Ltd., Tokyo (JP)

(21) Appl. No.: 12/990,219

(22) PCT Filed: Apr. 23, 2009
(86) PCT No.: PCT/JP2009/058101

§ 371 Date: Oct. 29, 2010

(30) Foreign Application Priority Data
Apr. 30, 2008 (JP) 2008-118759

(51) Int. Cl. H01M 4/58; H01M 4/583; H01B 1/24; H01B 1/22

(52) U.S. Cl. 429/218.1; 429/231.8; 252/510; 252/512; 252/519.3

(57) ABSTRACT

The invention aims to improve the charge/discharge cycle characteristics of an anodic carbon material for a lithium secondary battery. An anodic carbon material for a lithium secondary battery according to the present invention comprises: particles containing carbon, or a metal or metalloid, or an alloy, oxide, nitride, or carbide thereof, the particle capable of absorbing and releasing lithium ions; a resinous carbon material enclosing the particles; and a network structure formed from carbon nanofibers and/or carbon nanotubes that bond to the surfaces of the particles and that enclose the particles.

### TECHNICAL FIELD

The present invention relates to an anodic carbon material for a lithium secondary battery and a method for manufacturing the anodic carbon material; the invention also relates to a lithium secondary battery anode and a lithium secondary battery.

### BACKGROUND ART

With the widespread use of portable, cordless electronic appliances, the need for smaller and lighter lithium secondary batteries or for lithium secondary batteries with higher energy density has been increasing. To increase the energy density of lithium secondary batteries, it is known to employ tin, silicon, germanium, aluminum, or their oxides or alloys, to be alloyed with lithium as the materials for their anodes. However, any such anodic material expands in volume during charging as the material absorbs lithium ions, and contracts in volume during discharge as it releases lithium ions. It is known that, since the volume of the anodic material changes during charge/discharge cycling, as described above, the anodic material eventually becomes comminuted, resulting in the disintegration of the anode.

It is known to provide an anodic material for a lithium secondary battery having excellent charge/discharge cycle characteristics by first loading a catalyst onto the surfaces of the nuclei of the active material containing a metal or metalloid that can form a lithium alloy, and then performing chemical vapor deposition thereby bonding a plurality of carbon fibers at their designated ends to the surfaces of the nuclei of the active material (for example, refer to patent document 1). According to the anodic material disclosed in patent document 1, since the conductivity between the nuclei of the active material is ensured by the entanglement of numerous carbon fibers, the conductivity is essentially unaffected by the volumetric expansion/contraction of the anodic material during charge/discharge cycling. The carbon fibers described in patent document 1 are formed by chemical vapor deposition and are distinguishable from those formed by carbonizing a carbon precursor.

It is also known to provide, in connection with a technique for extending the life of the anode disclosed in patent document 1, a nonaqueous electrolyte secondary battery anode which includes a current collector and a composite anode active material composed at least of silicon-containing particles capable of absorbing and releasing lithium ions, carbon nanofibers made to adhere to the surfaces of the silicon-containing particles, and a catalytic element for promoting the growth of the carbon nanofibers, wherein the silicon-containing particles are bound to the current collector by a first binding agent and the carbon nanofibers are bound together by a second binding agent (patent document 2). According to the anode disclosed in patent document 2, there is provided a nonaqueous electrolyte secondary battery having a high capacity and excellent charge/discharge cycle characteristics. The carbon nanofibers described in patent document 2 are formed by vapor phase growth and are distinguishable from those formed by carbonizing a carbon precursor.

It is also known to provide, as an anodic material for a lithium secondary battery, a carbon material which includes fibrous carbon and carbon particles formed by making a carbonaceous material containing Si and/or an Si compound to adhere to at least a portion of the surface of each carbon particle having a graphitic structure, wherein the carbonaceous material is obtained by heat-treating a composition containing a polymer (patent document 3). According to the carbon material comprising the fibrous carbon described in patent document 3, contact between the particles is maintained at a sufficient level even after repeated charge/discharge cycles, and the carbon material thus contributes to improving the cycle characteristics of the secondary battery. The fibrous carbon described in patent document 3 are formed by vapor phase growth and are distinguishable from those formed by carbonizing a carbon precursor.

### PRIOR ART DOCUMENTS

### Patent Documents

Patent document 1: Japanese Unexamined Patent Publication No. 2004-349056

Patent document 2: Japanese Unexamined Patent Publication No. 2007-165078

Patent document 3: Japanese Unexamined Patent Publication No. 2004-182512

### Problem to be Solved by the Invention

In the lithium secondary battery anode described in any one of the above patent documents 1 to 3, the degradation of conductivity due to the volumetric expansion/contraction of the anode active material during charge/discharge cycling is suppressed to a certain degree by incorporating carbon nanofibers into the material. However, with the invention disclosed in any one of patent documents 1 and 2, it is not possible to prevent the disintegration of the anode which can result from the commination of the anode active material due to repeated charge/discharge cycles. On the other hand, in the invention disclosed in patent document 3, the adhesion between the anode active material and the fibrous carbon degrades due to the volumetric expansion/contraction of the anode active material during charge/discharge cycling, and as a result, the conductivity degrades. Accordingly, it cannot be said that the lithium secondary battery anode described in each of the above patent documents 1 to 3 has satisfactory charge/discharge cycle characteristics. It is accordingly an object of the present invention to further improve the charge/discharge cycle characteristics of an anodic carbon material for a lithium secondary battery.

### Means for Solving the Problem

The above object is achieved by the present invention described in items (1) to (8) below.

(1) An anodic carbon material for a lithium secondary battery, comprising:

particles containing carbon, or a metal or metalloid, or an alloy, oxide, nitride or carbide thereof, the particle capable of absorbing and releasing lithium ions;

a resinous carbon material enclosing the particles; and

a network structure formed from carbon nanofibers and/or carbon nanotubes that bond to the surfaces of the particles and that enclose the particles.

(2) An anodic carbon material for a lithium secondary battery as described in item (1), wherein the resinous carbon material and the network structure are formed by carbonizing a carbon precursor containing a catalyst.

(3) An anodic carbon material for a lithium secondary battery as described in item (2), wherein the catalyst includes at least one element selected from the group consisting of copper, iron, cobalt, nickel, molybdenum, and manganese.

(4) An anodic carbon material for a lithium secondary battery as described in items (2) or (3), wherein the carbon precursor includes a graphitizable material and/or a non-graphitizable material selected from the group consisting of petroleum pitch, coal pitch, a phenol resin, a furan resin, an epoxy resin, and polyacrylonitrile.

(5) An anodic carbon material for a lithium secondary battery as described in any one of items (1) to (4), wherein the metal or metalloid includes at least one element selected from the group consisting of silicon, tin, germanium, and aluminum.

(6) A method for manufacturing an anodic carbon material for a lithium secondary battery, comprising: mixing particles containing carbon, or a metal or metalloid, or an alloy, oxide, nitride, or carbide thereof, the particle capable of absorbing and releasing lithium ions, into a carbon precursor and a catalyst, thereby forming a mixture with the catalyst adhering to the surfaces of the particles and with the particles dispersed through the carbon precursor; and carbonizing the mixture.

(7) A lithium secondary battery anode comprising an anodic carbon material for a lithium secondary battery as described in any one of items (1) to (5).

(8) A lithium secondary battery comprising a lithium secondary battery anode as described in item (7).

### EFFECT OF THE INVENTION

According to the present invention, since the degradation of the anodic carbon material is suppressed by preventing the commination of the carbon material associated with repeated charge/discharge cycles, while maintaining the adhesion to the carbon nanofibers and/or carbon nanotubes, there is provided, for a lithium secondary battery, an anodic carbon material that exhibits excellent charge/discharge cycle characteristics that have not been possible with the prior art. Further, in the anodic carbon material for the lithium secondary battery according to the present invention, since the resinous carbon material and the carbon nanofibers and/or carbon nanotubes are simultaneously formed from the same carbon precursor in the carbonizing process, the carbon nanofibers and/or carbon nanotubes need not be prepared in a separate process using a vapor phase method, and the manufacturing process can be simplified accordingly.

### BRIEF DESCRIPTION OF THE DRAWINGS

FIG. 1 is a scanning electron micrograph showing the particle shape of a carbon material obtained in working example 1.

FIG. 2 is a scanning electron micrograph showing the particle shape of the carbon material obtained in working example 1.

FIG. 3 is a scanning electron micrograph showing the particle shape of a carbon material obtained in working example 2.

FIG. 4 is a scanning electron micrograph showing the particle shape of a carbon material obtained in comparative example 1.

### MODES FOR CARRYING OUT THE INVENTION

An anodic carbon material for a lithium secondary battery, a method for manufacturing the anodic carbon material, a lithium secondary battery anode, and a lithium secondary battery will be described in detail below in accordance with the present invention.

An anodic carbon material for a lithium secondary battery according to the present invention comprises: particles containing carbon, or a metal or metalloid, or an alloy, oxide, nitride, or carbide thereof, the particle capable of absorbing and releasing lithium ions; a resinous carbon material enclosing the particles; and a network structure formed from carbon nanofibers and/or carbon nanotubes (hereinafter called the “carbon nanofibers, etc.”) that bond to the surfaces of the particles and that enclose the particles. The network structure formed from the carbon nanofibers, etc. is formed by carbonizing a carbon precursor with the surface of each particle as the starting point.

While not wishing to be bound by any specific theory, it is believed that the network structure formed from the carbon nanofibers, etc., that bond to the surfaces of a particle capable of absorbing and releasing lithium ions, and that enclose the particle, gets entangled with a network structure formed from other adjacent particles. This serves to enhance the adhesion between the carbon nanofibers, etc., and the particles, making the carbon nanofibers, etc., difficult to separate from the particles when the particles expand and contract in volume during charge/discharge cycling. Furthermore, since the entanglement of the adjacent particle network structures results in the formation of a network structure having elasticity as a whole, the conductivity of the anode as a whole is maintained despite the volumetric expansion/contraction of the particles during charge/discharge cycling. The network structure unique to the present invention cannot be formed by simply adding the carbon nanofibers, etc., formed in a separate process using a vapor phase method as in the prior art.

Examples of the carbon capable of absorbing and releasing lithium ions include carbon black, acetylene black, graphite, thermally calcined carbon, charcoal, etc. Examples of the metal or metalloid capable of absorbing and releasing lithium ions include silicon (Si), tin (Sn), germanium (Ge), aluminum (Al), etc. Examples of the alloy, oxide, nitride, or carbide formed with such a metal or metalloid include silicon monoxide SiO), silicon nitride (Si₃N₄), silicon carbide (SiC), tin oxide (SnO), tin nitride (SnN), tin carbide (SnC), germanium monoxide (GeO), germanium nitride (Ge₃N₄), germanium carbide (GeC), aluminum oxide (Al₂O₃), aluminum nitride (AlN), aluminum carbide (Al₄C₃), an aluminum-lithium alloy (Al—Li), a titanium-silicon alloy (Ti—Si), etc. Of these metals and metalloids, Si and Sn are preferable because of their high energy density, and their oxides are more preferable because the expansion coefficient during charging is lower than that of Si or Sn alone.

The particles of the carbon or the metal or metalloid capable of absorbing and releasing lithium ions are not limited to any specific shape, but may take any desired shape, such as a mass-like shape, a flake-like shape, a spherical shape, or a fiber-like shape. It is preferable to set the lower limit of the particle size, in terms of the median particle size D50 as measured by a laser diffraction particle size distribution measurement method, to 0.1 μm or larger, and more preferably to 1.0 μm or larger, because if the surface area is made large, the charge/discharge efficiency significantly drops due to side effects associated with the charge/discharge reactions. Conversely, if the particle size is made large, the gap between the particles becomes large and, as a result, the particle packing density decreases, the thickness of the anode becomes excessive, and the adhesion to the current collector decreases; for these and other reasons, it is preferable to set the upper limit of the particle size, in terms of the median particle size D50, to 100 μm or less, and more preferably to 50 μm or less. The particle size distribution can be adjusted using a known grinding method and a known classifying method. Examples of the grinding machine used for this purpose include a hammer mill, a jaw crasher, an impact grinder, etc. Examples of the classifying method include an air sifting method and a sieving method, and examples of the air sifter include a turbo classifier, Turboplex, etc.

The network structure unique to the present invention described above can be formed by first mixing the particles containing the carbon, or the metal or metalloid, or an alloy, oxide, nitride, or carbide thereof, the particle capable of absorbing and releasing lithium ions, into a carbon precursor and a catalyst, thereby forming a mixture with the catalyst adhering to the surfaces of the particles and with the particles dispersed through the carbon precursor, and then carbonizing the mixture.

Examples of the carbon precursor include a graphitizable material or a non-graphitizable material selected from the group consisting of petroleum pitch, coal pitch, a phenol resin, a furan resin, an epoxy resin, and polyacrylonitrile. A mixture of a graphitizable material and a non-graphitizable material may be used. Further, a curing agent (for example, hexamethylene tetramine) may be included in the phenol resin, etc. In that case, the curing agent can form part of the carbon precursor.

Examples of the catalyst include one that contains at least one element selected from the group consisting of copper (Cu), iron (Fe), cobalt (Co), nickel (Ni), molybdenum (Mo), and manganese (Mn). The catalytic element may be one that is contained as an impurity in the carbon precursor. In that case, it may not be necessary to separately prepare the catalyst and mix it with the precursor. It is preferable to mix the catalytic element in the form of a solution with the particles so that the catalyst is made to adhere to the surfaces of the particles. To provide such a solution, it is preferable to prepare the catalytic element as a metallic salt compound, examples of which include copper nitrate, iron nitrate, cobalt nitrate, nickel nitrate, molybdenum nitrate, manganese nitrate, etc. The solvent used to produce such a solution should be suitably selected from among water, an organic solvent, and a mixture of water and an organic solvent; specifically, examples of the organic solvent include ethanol, isopropyl alcohol, toluene, benzene, hexane, tetrahydrofuran, etc.

When the mixture produced by mixing the particles, carbon precursor, and catalyst together is carbonized, the carbon precursor is converted into a resinous carbon material, while at the same time, the carbon nanofibers, etc., are grown with the catalyst adhering to the surface of each particle as the starting point, and the network structure is formed with the thus grown carbon nanofibers, etc., becoming entangled with the carbon nanofibers, etc., grown from other adjacent particles. The particles are mixed so that they preferably occupy 5 to 95% by mass, and more preferably 10 to 80% by mass, in the carbon material produced by carbonizing. The precursor is mixed so that the resinous carbon material resulting from the carbonizing preferably occupies 5 to 95% by mass, and more preferably 20 to 90% by mass, in the carbon material. When determining the amount of mixing of the carbon precursor, account should be taken of the factors, such as the kind of the carbon precursor and the carbonizing conditions to be described later, that affect the rate of conversion to the resinous carbon material. The catalyst is mixed preferably in an amount of 0.001 to 20% by mass, and more preferably in an amount of 0.01 to 5% by mass, relative to the total mass of the particles. When using a solvent, the solvent is added preferably in an amount not larger than 70% by mass, and more preferably in an amount not larger than 50%, relative to the total mass of the mixture.

The method of mixing the particles, carbon precursor, and catalyst together is not limited to any specific method, but any suitable method may be employed, including a method of dissolving or mixing in a solution using an agitator such as a Homo Disper or a homogenizer, a method of mixing by grinding using a grinder such as a centrifugal grinder, a free mill, or a jet mill, and a method of mixing by kneading using a mortar and a pestle. The order in which the particles, the carbon precursor, and the catalyst are mixed together is not specifically limited, but first the carbon precursor, and then the particles (preloaded with the catalyst) may be added into the solvent (if used). When grinding the material in the carbonizing process, a known grinder, such as a free mill, a jet mill, a vibrating mill, or a ball mill, may be used.

The heating temperature for carbonizing may be suitably set, preferably in the range of 600 to 1400° C., and more preferably in the range of 800 to 1300° C. The rate at which the temperature is raised up to the heating temperature is not specifically limited, but may be set preferably in the range of 0.5 to 600° C./hour, and more preferably in the range of 20 to 300° C./hour. The duration of time that the material is held at the heating temperature may be suitably set, preferably not longer than 48 hours, and more preferably in the range of 1 to 12 hours. The carbonizing may be performed in a reducing atmosphere such as an argon, nitrogen, carbon dioxide, or hydrogen atmosphere.

As described above, in the anodic carbon material for the lithium secondary battery according to the present invention, since the resinous carbon material and the carbon nanofibers, etc., are simultaneously formed from the same carbon precursor in the carbonizing process, the carbon nanofibers, etc., need not be prepared in a separate process using a vapor phase method, and the manufacturing process can be simplified accordingly.

By using the thus obtained carbon material as the anode active material, the lithium secondary battery anode of the present invention can be fabricated. The lithium secondary battery anode of the present invention can be fabricated using a prior known method. For example, a binder, a conductive agent, etc., are added to the carbon material obtained as the anode active material according to the present invention, and the resulting mixture is dissolved in a suitable solvent or dispersion medium to produce a slurry having a desired viscosity; then, the slurry is applied over a current collector of a metal foil or the like to form thereon a coating several micrometers to several hundred micrometers in thickness. The solvent or dispersion medium is removed by heat-treating the coating at about 50 to 200° C., to complete the fabrication of the anode according to the present invention.

Any prior known material may be used as the binder in the fabrication of the anode according to the present invention; for example, use may be made of a polyvinylidene fluoride resin, polytetrafluorethylene, a styrene-butadiene copolymer, a polyimide resin, a polyamide resin, polyvinyl alcohol, polyvinyl butyral, etc. Further, any known material commonly used as a conductive agent may be used as the conductive agent in the fabrication of the anode according to the present invention; examples include graphite, acetylene black, and Ketjen black. Furthermore, any known material that can help to uniformly mix the anode active material, binder, conductive agent, etc., may be used as the solvent or dispersion medium in the fabrication of the anode according to the present invention; examples include N-methyl-2-pyrrolidone, methanol, and acetanilide.

By using the lithium secondary battery anode of the present invention, the lithium secondary battery of the present invention can be fabricated. The lithium secondary battery of the present invention can be fabricated using a prior known method, and generally includes, in addition to the anode of the present invention, a cathode, an electrolyte, and a separator for preventing short-circuiting between the anode and the cathode. If the electrolyte is a solid electrolyte complexed with a polymer that also serves as a separator, there is no need to provide an independent separator.

The cathode for the lithium secondary battery of the present invention can be fabricated using a prior known method. For example, a binder, a conductive agent, etc. are added to the cathode active material, and the resulting mixture is dissolved in a suitable solvent or dispersion medium to produce a slurry having a desired viscosity; then, the slurry is applied over a current collector of a metal foil or the like to form thereon a coating several micrometers to several hundred micrometers in thickness, and the solvent or dispersion medium is removed by heat-treating the coating at about 50 to 200° C. Any prior known material may be used as the cathode active material; for example, use may be made of a cobalt-containing composite oxide such as LiCoO₂, a manganese-containing composite oxide such as LiMn₂O₄, a nickel-containing composite oxide LiNiO₂, a mixture of these oxides, an oxide in which a portion of the nickel in LiNiO₂ is replaced by cobalt or manganese, or an iron-containing composite oxide such as LiFeVO₄ or LiFePO₄.

Any prior known electrolyte may be used as the electrolyte for the lithium secondary battery of the present invention, and use may be made of an electrolyte that contains a lithium salt as an essential component and an additive such as an ambient-temperature molten salt, a polymer, a flame-retardant electrolyte solvent, a plasticizer, etc. Such an electrolyte can be prepared using a prior known method; for example, it can be prepared by dissolving the lithium salt in the plasticizer or the ambient-temperature molten salt. If the polymer is to be included, the electrolyte can be prepared by preparing a solution with the above-mentioned components dissolved in an organic solvent such as alcohol or acetonitrile and thereafter removing the organic solvent by heating, etc. In order to enhance the charge/discharge characteristics of the lithium secondary battery, it is preferable to use an electrolyte that contains the ambient-temperature molten salt, and more preferably an electrolyte in which the anion component of the ambient-temperature molten salt has a fluorosulfonyl group.

Examples of the lithium salt include LiPF₆, LiClO₄, LiCF₃SO₃, LiBF₄, LiAsF₆, LiN(CF₃SO₂)₂, LiN(C₂F₅SO₂)₂, LiC(CF₃SO₂)₃, and an ambient-temperature molten salt that contains a Li ion as a cation component as in the lithium salt described in Japanese Unexamined Patent Publication No. 2004-307481. These lithium salts may be used either singly or as a combination of two or more salts. The lithium salt is added usually in an amount of 0.1 to 89.9% by mass, and preferably in an amount of 1.0 to 79.0% by mass, relative to the total mass of the electrolyte. Components other than the lithium salt in the electrolyte can be added in a suitable amount, provided that the lithium salt content is maintained within the above-stated range.

The ambient-temperature molten salt comprises a cation component and an anion component, and examples of the cation component include a cation having at least one group that occurs with a group of cation-type atoms attached by coordinate bonds to a compound containing an element having lone pair electrodes such as nitrogen, sulfur, oxygen, selenium, tin, iodine, antimony, etc. Examples of the anion component of the ambient-temperature molten salt include: an anion RO— formed by the removal of a proton from a compound containing a hydroxyl group, such as alcoholate, phenolate, etc.; an anion RS— formed by the removal of a proton from thiolate, thiophenolate, etc.; a sulfonic acid anion RSO₃—; a carboxylic acid anion RCOO—; a phosphorus-containing derivative anion Rₓ(OR)_{y}(O)_{z}P— (where x, y, and z are integers not smaller than 0 and satisfy the relation x+y+2z=3 or x+y+2z=5) in which some of the hydroxyl groups of phosphoric acid, phosphorous acid, etc. are replaced by organic groups; a substituted borate anion Rₓ(OR)_{y}B— (where x and y are integers not smaller than 0 and satisfy the relation x+y=4); a substituted aluminum anion Rₓ(OR)_{y}Al— (where x and y are integers not smaller than 0 and satisfy the relation x+y=4); an organic anion such as a nitrogen anion (EA)₂N—, a carbanion (EA)₃C—, etc. (where EA designates a hydrogen atom or an electron-absorbing group); and an inorganic anion such as a halogen ion, halogen-containing ion, etc.

The polymer for use in the electrolyte is not specifically limited, the only requirement being that the polymer be electrochemically stable and highly ionically conductive; for example, use may be made of an acrylate-based polymer, polyvinylidene fluoride, etc. A polymer synthesized from a substance containing a salt monomer comprising an onium cation having a polymerizable functional group and an organic anion having a polymerizable functional group is particularly preferable because such a polymer has a particularly high ionic conductivity and can contribute to further enhancing the charge/discharge characteristics. The polymer content of the electrolyte is preferably in the range of 0.1 to 50% by mass, and more preferably in the range of 1 to 40% by mass.

The flame-retardant electrolyte solvent is not specifically limited, the only requirement being that it be a compound having a self-extinguishing property and capable of dissolving an electrolyte salt while allowing the electrolyte salt to coexist; for example, use may be made of phosphate ester, halogen compounds, phosphazene, etc.

Examples of the plasticizer include cyclic carbonates such as ethylene carbonate, propylene carbonate, etc., and chain carbonates such as ethylmethyl carbonate, diethyl carbonate, etc. These plasticizers may be used either singly or as a combination of two or more plasticizers.

The separator for use in the lithium secondary battery of the present invention may be formed from any prior known material that is electrochemically stable and that can prevent short-circuiting between the cathode and anode. Examples of such separators include polyethylene separators, polypropylene separators, cellulose separators, nonwoven fabrics, inorganic-based separators, glass filters, etc. If a polymer is to be included in the electrolyte, the electrolyte may also serves as a separator; in that case, there is no need to provide an independent separator.

The lithium secondary battery of the present invention can be fabricated using a prior known method. For example, the cathode and anode fabricated as described above are each cut to a prescribed shape and size, and a single-layer cell is fabricated by bonding together the cathode and anode by interposing a separator therebetween. Next, an electrolyte may be injected into the space between the electrodes of the single-layer cell. Alternatively, the electrodes, separator, etc., may be impregnated in advance with the electrolyte, and then the electrodes and separator may be laminated together to fabricate the single-layer cell. The thus fabricated cell is packaged and hermetically sealed in an outer casing formed, for example, from a three-layered laminated film comprising a polyester film, an aluminum film, and a modified polyolefin film, to complete the fabrication of the lithium secondary battery.

When using a polymer synthesized from the earlier described salt monomer-containing substance for the separator, a mixture of the polymer, lithium salt, and ambient-temperature molten salt may be used. In this case, to enhance workability, the polymer may be diluted with a low-boiling solvent, such as tetrahydrofuran, methanol, acetonitrile, etc. The diluting solvent is thereafter removed, and the single-layer cell is fabricated by sandwiching the polymer-containing electrolyte between the cathode and anode; then, the lithium secondary battery can be fabricated as described above.

### EXAMPLES

Examples will be provided below in order to describe the present invention in further detail.

### Working Example 1

A carbon precursor, formed from 135 parts by mass of a novolac-type phenol resin (PR-50237 manufactured by Sumitomo Bakelite) and 25 parts by mass of hexamethylene tetramine (manufactured by Mitsubishi Gas Chemical), was mixed with 86 mL of ethanol to prepare an ethanol solution in which the novolac-type phenol resin and hexamethylene tetramine together account for 70% by mass of the total mixture.

Then, 100 parts by mass of silicon monoxide powder (mean particle size: 6 μm), 0.0043 parts by mass of iron nitrate, 0.00076 parts by mass of copper nitrate, 0.00104 parts by mass of molybdenum nitrate, and 0.0011 parts by mass of aluminum powder (all of the above materials are manufactured by Kanto Chemical) were added to 228 parts by mass of the ethanol solution, and the resulting solution was thoroughly stirred for three minutes at 3000 rpm by using a high-speed disperser (HOMO DISPER manufactured by PRIMIX Corporation), to obtain 325 g of compound resin.

Then, 300 g of the compound resin was put into a container (mullite sagger), and the container was placed in a carbonizing oven (manufactured by Sankei Vacuum). First, to remove volatile components from the compound resin, the temperature of the carbonizing oven was raised at a rate of 100° C./hour until the temperature reached 600° C., and the oven was held at that temperature for one hour. Then, after allowing the oven to cool down to room temperature, the container was retrieved from the oven. Next, the compound resin was put into a grinder (manufactured by Chuo Kakoh) and was ground until the particle size was reduced to 10 μm or less in terms of the median particle size D50 as measured by a laser diffraction particle size distribution measurement method.

The thus ground resin was once again put into the container, and the container was placed in the carbonizing oven. Next, in the carbonizing process, the temperature of the carbonizing oven was raised at a rate of 100° C./hour until the temperature reached 1100° C., and the oven was held at that temperature for six hours. After that, the container was retrieved from the oven and was allowed to cool down to room temperature, to obtain a composite carbon material.

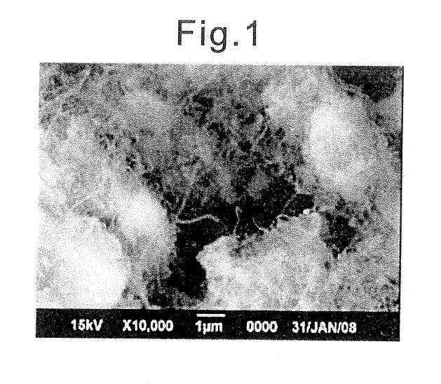

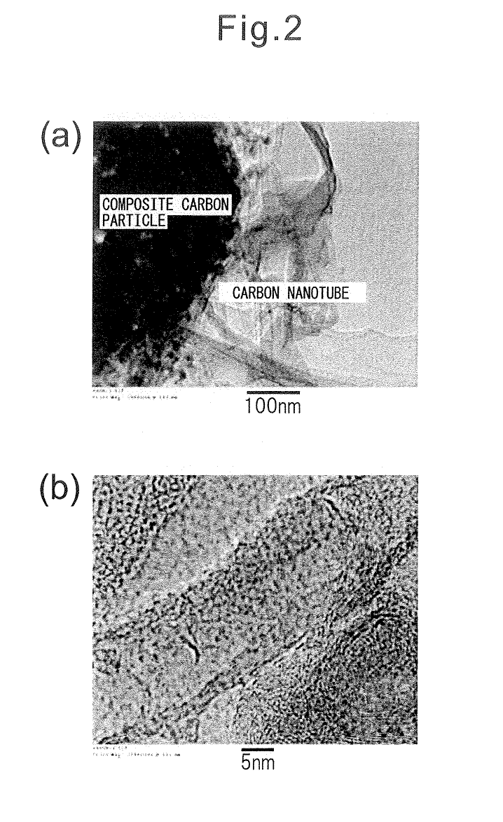

The result obtained by observing the composite carbon material through a scanning electron microscope is shown in FIG. 1 (in the form of an electron micrograph). As can be seen from FIG. 1, it was confirmed that the carbon nanofibers, etc., were grown from the surfaces of the particles of the composite carbon material so as to enclose the particles. The result obtained by observing the composite carbon material through the transmission electron microscope is also shown in parts (a) and (b) of FIG. 2 (in the form of an electron micrograph). Part (b) is an enlarged photograph showing a portion of part (a). As can be seen from FIG. 2, it was confirmed that the carbon nanotubes were grown from the surfaces of the particles of the composite carbon material so as to enclose the particles.

### Working Example 2

The procedure of working example 1 was repeated with the difference that, in the carbonizing process, the ground compound resin was held at 1100° C. for one hour, not for six hours.

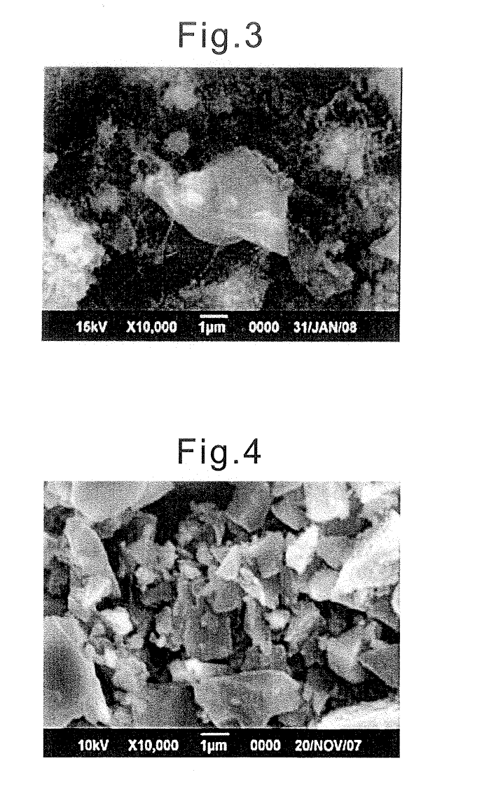

The result obtained by observing the composite carbon material through a scanning electron microscope is shown in FIG. 3 (in the form of an electron micrograph). As can be seen from FIG. 3, it was confirmed that the carbon nanofibers, etc., were grown from the surfaces of the particles of the composite carbon material so as to enclose the particles.

### Working Example 3

An ethanol solution containing 70% by mass of the carbon precursor was prepared in the same manner as in working example 1, and 100 parts by mass of silicon monoxide powder (mean particle size: 6 μm) and 110 ppm of Fe (0.07 parts by mass of iron nitrate) were added to 228 parts by mass of the ethanol solution, after which the resulting solution was thoroughly stirred in the high-speed disperser in the same manner as in working example 1, to obtain 328 g of compound resin. Then, 300 g of the compound resin was processed in the same manner as in working example 1, to obtain a composite carbon material.

When the thus obtained composite carbon material was observed under a scanning electron microscope, it was confirmed, as in FIG. 1, that the carbon nanofibers, etc., were grown from the surfaces of the particles of the composite carbon material so as to enclose the particles (not shown here).

### Working Example 4

After adding one part by mass of iron nitrate to 100 parts by mass of silicon powder (mean particle size: 50 μm), the mixture was kneaded in a mortar using a pestle, and a carbon precursor formed from 535 parts by mass of a novolac-type modified phenol resin (PR-55249 manufactured by Sumitomo Bakelite) was added and was ground and mixed together using a coffee mill, to obtain a compound resin.

Then, 500 g of the compound resin was processed in the same manner as in working example 1, to obtain a composite carbon material.

### Working Example 5

First, 300 parts by mass of a novolac-type modified phenol resin (PR-55249 manufactured by Sumitomo Bakelite) was put into a container (mullite sagger), and the container was placed in a carbonizing oven (manufactured by Sankei Vacuum); then, the temperature of the carbonizing oven was raised at a rate of 100° C./hour until the temperature reached 600° C., and the oven was held at that temperature for one hour. Then, after allowing the oven to cool down to room temperature, the container was retrieved from the oven. Next, the thus heat-treated material was put into a grinder (manufactured by Chuo Kakoh) and was ground until the particle size was reduced to 10 μm or less in terms of the median particle size D50 as measured by a laser diffraction particle size distribution measurement method.

After adding one part by mass of iron nitrate to 100 parts by mass of silicon monoxide powder (mean particle size: 6 μm), the mixture was kneaded in a mortar using a pestle. The kneaded material was then mixed with 83 parts by mass of the above ground material obtained as a carbon precursor, and the mixture was again put into the container, was placed in the carbonizing oven, and was processed in the same manner as in working example 1, to obtain a composite carbon material.

### Comparative Example 1

A composite carbon material was obtained by repeating the procedure of working example 4 with the difference that iron nitrate was not added.

The result obtained by observing the composite carbon material through a scanning electron microscope is shown in FIG. 4 (in the form of an electron micrograph). As can be seen from FIG. 4, it was confirmed that the particles of the composite carbon material were not enclosed by the carbon nanofibers, etc.

### Comparative Example 2

A composite carbon material was obtained by repeating the procedure of working example 5 with the difference that iron nitrate was not added.

Evaluation of Charge/Discharge Characteristics

(1) Fabrication of Anode

For the composite carbon material obtained in each of the above examples, 10% by mass of polyvinylidene fluoride as a binder and 3% by mass of acetylene black as a conductive agent were added, and were mixed together by adding a suitable amount of N-methyl-2-pyrrolidone as a solvent, to prepare an anodic slurry. The anodic slurry was applied over both surfaces of a current collector formed from a 10-μm thick copper foil, and the coating films thus formed on both surfaces were vacuum dried at 110° C. for one hour. After vacuum drying, the structure was molded under pressure using a roll press to form an electrode with a thickness of 100 μm. Then, the electrode was cut into a shape measuring 40 mm in width and 290 mm in length to form an anode. The anode was then punched out with a diameter of 13 mm to complete the fabrication of an anode for a lithium-ion secondary battery.

(2) Fabrication of Lithium-Ion Secondary Battery

The above anode, a separator (polypropylene porous film, 45 mm wide and 25 μm thick), and a lithium metal (1 mm thick) as a working electrode were placed in this order at prescribed positions in a two-electrode charge/discharge test cell (manufactured by Hohsen Corporation). Then, an electrolytic solution, prepared by dissolving lithium perchlorate in a concentration of 1 mole per liter into a mixture of ethylene carbonate and diethyl carbonate (volume ratio 1:1), was injected into the cell to fabricate a lithium-ion secondary battery.

(3) Evaluation

To evaluate the charge capacity, the cell was charged at a constant current with a current density of 25 mA/g; when the potential reached 0 V, the cell was charged at a constant voltage of 0 V, and the amount of electricity charged until the current density reached 1.25 mA/g was taken as the charge capacity.

On the other hand, to evaluate the discharge capacity, the cell was discharged at a constant current with the same current density of 25 mA/g, and the amount of electricity discharged until the potential reached 2.5 V was taken as the discharge capacity.

The initial charge/discharge efficiency was defined by the following equation.

Initial charge/discharge efficiency(%)=Initial discharge capacity(mAh/g)/Initial charge capacity(mAh/g)×100

With the above charge and discharge steps as one cycle, 30 charge/discharge cycles were performed, and the discharge capacity retention rate after the 30 cycles was calculated by dividing the discharge capacity retained after the 30 cycles by the initial discharge capacity and expressing the result as a percentage.

The evaluation results are shown in Table 1.

TABLE 1

| | Working | Working | Working | Working | Working | Comparative | Comparative |
|---|---|---|---|---|---|---|---|
| | example 1 | example 2 | example 3 | example 4 | example 5 | example 1 | example 2 |
| Initial discharge | 655 | 980 | 700 | 900 | 1000 | 1300 | 1000 |
| capacity (mAh/g) | | | | | | | |
| Initial | 70 | 70 | 73 | 82 | 65 | 80 | 40 |
| charge/discharge | | | | | | | |
| efficiency (%) | | | | | | | |
| Discharge | 100 | 95 | 100 | 85 | 80 | 10 | 3 |
| capacity | | | | | | | |
| retention rate | | | | | | | |
| after 30 cycles | | | | | | | |
| (%) | | | | | | | |

As is apparent from Table 1, the lithium-ion secondary batteries of working examples 1 to 5 each exhibited a discharge capacity retention rate of 80% or higher after the 30 cycles, a significant improvement over comparative examples 1 and 2 whose discharge capacity retention rate was 10% or less. The reason for this is believed to be that, as shown in FIGS. 1 to 3, in the working examples, the carbon nanofibers, etc., were grown from the surfaces of the particles of the composite carbon material so as to enclose the particles, suppressing the commination of the anodic carbon material associated with the expansion/contraction of the material during charge/discharge cycling. In the comparative examples, on the other hand, since there were no carbon nanofibers, etc., enclosing the particles, as shown in FIG. 4, the commination of the anodic carbon material associated with the expansion/contraction of the material during charge/discharge cycling proceeded, and the anode virtually disintegrated.

1. An anodic carbon material for a lithium secondary battery, comprising:
particles containing carbon, or a metal or metalloid, or an alloy, oxide, nitride or carbide thereof, the particle capable of absorbing and releasing lithium ions;
a resinous carbon material enclosing said particles; and
a network structure formed from carbon nanofibers and/or carbon nanotubes that bond to the surfaces of said particles and that enclose said particles.

2. An anodic carbon material for a lithium secondary battery as claimed in claim 1, wherein said resinous carbon material and said network structure are formed by carbonizing a carbon precursor containing a catalyst.

3. An anodic carbon material for a lithium secondary battery as claimed in claim 2, wherein said catalyst includes at least one element selected from the group consisting of copper, iron, cobalt, nickel, molybdenum, and manganese.

4. An anodic carbon material for a lithium secondary battery as claimed in claim 1, wherein said carbon precursor includes a graphitizable material and/or a non-graphitizable material selected from the group consisting of petroleum pitch, coal pitch, a phenol resin, a furan resin, an epoxy resin, and polyacrylonitrile.

5. An anodic carbon material for a lithium secondary battery as claimed in claim 1, wherein said metal or metalloid includes at least one element selected from the group consisting of silicon, tin, germanium, and aluminum.

6. A method for manufacturing an anodic carbon material for a lithium secondary battery, comprising: mixing particles containing carbon, or a metal or metalloid, or an alloy, oxide, nitride, or carbide thereof, the particle capable of absorbing and releasing lithium ions, into a carbon precursor and a catalyst, thereby forming a mixture with said catalyst adhering to the surfaces of said particles and with said particles dispersed through said carbon precursor; and carbonizing said mixture.

7. A lithium secondary battery anode comprising an anodic carbon material for a lithium secondary battery as claimed in any one of claims 1 to 5.

8. A lithium secondary battery comprising a lithium secondary battery anode as claimed in claim 7.
